(19) United States
(12) Patent Application Publication
(10) Pub. No.: US 2018/0196315 A1
(43) Pub. Date: Jul. 12, 2018

(54) RUBBING ALIGNMENT METHOD AND DISPLAY PANEL MANUFACTURED BY THE METHOD

(71) Applicants: BOE TECHNOLOGY GROUP CO., LTD., Beijing (CN); HEFEI XINSHENG OPTOELECTRONICS TECHNOLOGY CO., LTD., Anhui (CN)

(72) Inventors: Hongwei GUO, Beijing (CN); Kai WANG, Beijing (CN); Wenming REN, Beijing (CN)

(21) Appl. No.: 15/534,070

(22) PCT Filed: Jan. 3, 2017
(86) PCT No.: PCT/CN2017/000049

§ 371 Date: Jun. 8, 2017

(30) Foreign Application Priority Data
Apr. 14, 2016 (CN) 201610230042.3

(51) Int. Cl. G02F 1/1337

(52) U.S. Cl. CPC G02F 1/133784

(57) ABSTRACT

A rubbing alignment method and a display panel manufactured by this method, the rubbing alignment method includes: rubbing an alignment layer on a surface of a substrate by a roller attached with a rubbing cloth and rotating in a first direction; and further rubbing the alignment layer on the surface of the substrate by the roller attached with the rubbing cloth and rotating in a second direction opposite to the first direction.

### CROSS-REFERENCE TO RELATED APPLICATIONS

The present application is based on International Application No. PCT/CN2017/000049, filed on Jan. 3, 2017, which is based upon and claims priority to Chinese Patent Application No. 201610230042.3, filed Apr. 14, 2016, and the entire contents thereof are incorporated herein by reference.

### TECHNICAL FIELD

The present disclosure relates to the field of manufacturing a liquid crystal display panel, and more particularly, to a method of rubbing an alignment layer in a liquid crystal display panel and a liquid crystal display panel manufactured by the method.

### BACKGROUND

In a conventional production process, an alignment film (also referred to as an oriented film or an orientation film, etc.) such as polyimide (PI) is coated on a glass substrate including a color film substrate and an array substrate of a liquid crystal display panel. The alignment film may make liquid crystal molecules have a pretilt angle. And then the alignment film is rubbed by a roller to which a rubbing cloth is attached, so as to form grooves arranged in a certain direction on the surface of the alignment film. The grooves have the function of anchoring the liquid crystal molecules. The liquid crystal molecules in the uncharged state can be arranged in a certain direction. In this way, in the liquid crystal display technique, the deflecting direction of the liquid crystal molecules is further controlled by an electric field, thereby the transmittance of the light generated by the backlight source and being passing through the liquid crystal display panel can be controlled, such that the liquid crystal display panel can exhibit various brightness.

It should be noted that, information disclosed in the above background portion is provided only for better understanding of the background of the present disclosure, and thus it may contain information that does not form the prior art known by those ordinary skilled in the art.

### SUMMARY

The present disclosure provides a rubbing alignment method. The rubbing alignment method comprises: rubbing an alignment layer on a surface of a substrate by a roller attached with a rubbing cloth and rotating in a first direction; and further rubbing the alignment layer on the surface of the substrate by the roller attached with the rubbing cloth and rotating in a second direction opposite to the first direction.

The present disclosure provides a display panel manufactured by the above described method.

### BRIEF DESCRIPTION OF THE DRAWINGS

In order to more clearly illustrate the technical solutions in embodiments of the present disclosure or the related art, the accompanying drawings of the embodiments will be briefly described below. Apparently, the drawings in the following description are only related to some embodiments of the present disclosure, and other drawings may be obtained by those skilled in the art without making creative effort. When read in conjunction with the accompanying drawings, various aspects of embodiments of the present disclosure and their further objects and advantages will be better understood by reference to the following detailed description of illustrative embodiments, and in the drawings:

FIG. 1 is a view showing a rubbing alignment method according to exemplary embodiments of the present disclosure.

### DETAILED DESCRIPTION

In order to make the objective, technical solutions and advantages of the embodiments of the present disclosure to be more apparent, the technical solutions in the embodiments of the present disclosure will be clearly and thoroughly described in combination with the drawings. Apparently, the described embodiments are merely part of the embodiments and not all of the embodiments of the present disclosure. Based on the embodiments of the present disclosure, all other embodiments obtained by those of ordinary skill in the art without making creative effort are within the protection scope of the present disclosure.

Throughout this specification, reference to features, advantages, or similar terms does not imply that all features and advantages that may be practiced with the present disclosure are intended to be or in any single embodiment of the present disclosure. Rather, it is to be understood that the reference to features, advantages means that the specific features, advantages or characteristics described in connection with the embodiments are included in at least one embodiment of the present disclosure. Thus, throughout the specification, discussion of features and advantages, and the like may refer to the same embodiment, but not necessarily to the same embodiment. In addition, the features, advantages, and characteristics of the described disclosure may be incorporated in one or more embodiments in any suitable manner. Those skilled in the art will recognize that the present disclosure may be practiced without one or more specific features or advantages of a particular embodiment. In other examples, additional features and advantages may be implemented in certain embodiments, which are not necessarily apparent in all embodiments of the present disclosure.

In the description of the present disclosure, it is to be noted that the azimuth or positional relationship indicated by the terms “upper”, “lower”, “top”, “bottom” and the like is based on the azimuth or positional relationship shown in the drawings, is only for convenience describing the present disclosure and simplifying description, and is not intended or implied that the means or elements referred to must have a particular orientation and be constructed and operated in a particular orientation and therefore can not be construed as limiting the disclosure.

In addition, in the description of the present disclosure, unless otherwise indicated, the meaning of “a plurality of” is two or more.

However, in a production process, the roller to which the rubbing cloth is attached is usually rotated in one direction, thus the segment-difference portions in a side of the pixel edge can not be effectively brought into contact with the rubbing cloth since they are shielded from the signal line. And thus uniform and effective alignment can not be formed. The cell-assembly liquid crystal molecules in this position are arranged randomly, and can not be ordered, resulting in light leakage phenomenon occurring at the pixel edge.

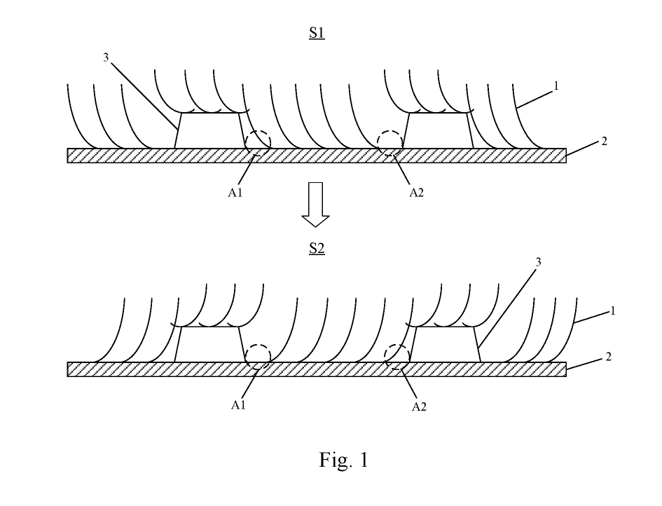

FIG. 1 is a view showing a rubbing alignment method according to exemplary embodiments of the present disclosure. For the sake of simplicity, the entirety of the roller attached with a rubbing cloth is not shown in FIG. 1, but only rubbing cloth fluff 1 of the rubbing cloth which can rub the alignment film is shown. The substrate coated with an alignment film in this embodiment is exemplified by an array substrate 2 shown in FIG. 1, but the present disclosure is not limited thereto. A color film substrate in a liquid crystal display panel may be applicable. In the present embodiment, in the process of rubbing alignment, the data line 3 shown in FIG. 1 is taken as an example of a signal line shielding the segment-difference portions on a side of the pixel edge, but the present disclosure is not limited thereto. It is also applicable for taking a scanning line or the like as the signal line.

The rubbing alignment method according to the present embodiment shown in FIG. 1 comprises the following steps.

In step S1, during the horizontal movement of the array substrate 2 coated with an alignment film (not shown) relative to the roller (not shown) to which the rubbing cloth is attached, the roller is rotated in a first direction so that the rubbing cloth fluff 1 of the rubbing cloth can rub the alignment film.

In step S2, during the horizontal movement of the array substrate 2 coated with an alignment film relative to the roller to which the rubbing cloth is attached, the roller is rotated in a second direction so that the rubbing cloth fluff 1 of the rubbing cloth can rub the alignment film.

As shown in FIG. 1, in the step S1 of the present embodiment, the first direction is clockwise, that is, the roller attached with the rubbing cloth is rotated in the clockwise direction. In the step S2 of the present embodiment, the second direction is counter clockwise, that is, the roller to which the rubbing cloth is attached is rotated in the counter clockwise direction. However, the present invention is not limited thereto, and the first direction may be counter clockwise, and the second direction may be clockwise, and so on, as long as the first direction and the second direction are opposite to each other.

According to the horizontal movement of the array substrate 2 coated with an alignment film relative to the roller to which the rubbing cloth is attached, when the array substrate 2 moves horizontally, the roller rotates only, without moving, in the horizontal direction of the array substrate 2. Or, when the array substrate 2 does not move horizontally, the roller can roll in the horizontal direction, and so on, so long as the array substrate 2 moves horizontally relative to the roller. In addition, the movement of the array substrate 2 can be achieved by the movement of the base (not shown) for carrying a substrate.

Further, the horizontal movement direction of the array substrate 2 coated with an alignment film relative to the roller to which the rubbing cloth is attached is opposite to the tangential speed direction of the bottom portion of the roller. So that even in range of the low rotational speed of the roller, rubbing direction of the rubbing cloth fluff in the step S1 and rubbing direction of the rubbing cloth fluff in the step S2 shown in FIG. 1 can be maintained respectively. Thus unified alignment can be ensured respectively in steps S1 and S2, so as to finally form uniform and effective alignment.

For example, in the step S1 shown in FIG. 1, when the roller to which the rubbing cloth is attached rotates in the clockwise direction, the horizontal movement direction of the array substrate 2 coated with an alignment film relative to the roller may be from left to right. In the step S2 shown in FIG. 1, when the roller to which the rubbing cloth is attached rotates in the counter clockwise direction, the horizontal movement direction of the array substrate 2 coated with an alignment film relative to the roller can be from right to left.

As shown in the step S1 of FIG. 1, for regions A1 and A2 of the segment-difference portions on both sides of the pixel edge, the region A1 is in effective contact with the rubbing cloth fluff 1. However, the region A2 can not be effectively brought into contact with the rubbing cloth since it is shielded from the data line 3. As shown in step S2 of FIG. 1, the region A2 is in effective contact with the rubbing cloth fluff 1, although the region A1 can not be effectively brought into contact with the rubbing cloth fluff 1 since it is shielded from the data line 3, the region A1 has, in the previous step S1, been effectively brought into contact with the rubbing cloth fluff 1. Therefore, uniform and effective alignment can finally be formed on the array substrate 2 coated with an alignment film shown in FIG. 1.

Further, in steps S1 and S2 shown in FIG. 1, a pressing depth of the rubbing cloth fluff can be adjusted so that same grooves are formed on the alignment film. Thus the pretilt angle of each liquid crystal molecule is same with each other so as to ensure that unified, uniform and effective alignment can finally be formed on the array substrate 2 coated with an alignment film. In addition, the adjustment of the pressing depth of the rubbing cloth fluff can be performed by adjusting the height in the vertical direction of the roller to which the rubbing cloth is attached by means of a lifting equipment; or by adjusting the height of the base (stage) for carrying the substrate; or by adjusting the longitudinal pressure applied to the roller, and the like.

For example, the pressing depth of the rubbing cloth fluff in step S1 can be set to the same as that in the step S2 or different from that in the step S2. For example, the pressing depth of the rubbing cloth fluff in step S1 can be set to be smaller than that in the step S2, or the pressing depth of the rubbing cloth fluff in step S1 can be set to be larger than that in the step S2. All these settings are to ensure that the unified, uniform and effective alignment can finally be formed on the array substrate 2 coated with an alignment film.

Relative to the above steps S1 and S2, it is also possible to perform the steps respectively and repeatedly until the array substrate 2 coated with an alignment film finally forms unified, uniform and effective alignment.

As described above, the present disclosure is not limited thereto and may be applied to a color film substrate in a liquid crystal display panel. Therefore, a color film substrate coated with an alignment film may be rubbed in a manner similar to that of the above-described embodiment, so that unified, uniform and effective alignment can be achieved. A liquid crystal display panel which can prevent the light leakage and has good display effect can be manufactured by this rubbing alignment method.

Exemplary embodiments according to the present disclosure have been described above in connection with the accompanying drawings, but are merely exemplary and illustrative illustrations used to illustrate and explain the conceive of the present disclosure, concept, rather than limiting aspects of the invention. It will be understood by those skilled in the art that various modifications and variations can be made without departing from the spirit and essentiality of present disclosure, which fall within the scope of present disclosure. The above contents are merely exemplary implementations of the present disclosure and are not intended to limit the scope of the present disclosure, and the scope of present disclosure is defined by the appended claims.

1-7. (canceled)

8. A rubbing alignment method, comprising:
rubbing an alignment layer on a surface of a substrate by a roller attached with a rubbing cloth and rotating in a first direction; and
further rubbing the alignment layer on the surface of the substrate by the roller attached with the rubbing cloth and rotating in a second direction opposite to the first direction.

9. The method of claim 8, wherein a horizontal movement direction of the substrate relative to the roller is opposite to a tangential speed direction of a bottom portion of the roller.

10. The method of claim 8, wherein the first direction is clockwise, and the second direction is counter clockwise.

11. The method of claim 9, wherein the first direction is clockwise, and the second direction is counter clockwise.

12. The method of claim 8, wherein the first direction is counter clockwise, and the second direction is clockwise.

13. The method of claim 9, wherein the first direction is counter clockwise, and the second direction is clockwise.

14. The method of claim 8, wherein a pressing depth of rubbing cloth fluff of the rubbing cloth when rotating in the first direction is different from a pressing depth of the rubbing cloth fluff of the rubbing cloth when rotating in the second direction.

15. The method of claim 9, wherein a pressing depth of rubbing cloth fluff of the rubbing cloth when rotating in the first direction is different from a pressing depth of the rubbing cloth fluff of the rubbing cloth when rotating in the second direction.

16. The method of claim 10, wherein a pressing depth of rubbing cloth fluff of the rubbing cloth when rotating in the first direction is different from a pressing depth of the rubbing cloth fluff of the rubbing cloth when rotating in the second direction.

17. The method of claim 11, wherein a pressing depth of rubbing cloth fluff of the rubbing cloth when rotating in the first direction is different from a pressing depth of the rubbing cloth fluff of the rubbing cloth when rotating in the second direction.

18. The method of claim 12, wherein a pressing depth of rubbing cloth fluff of the rubbing cloth when rotating in the first direction is different from a pressing depth of the rubbing cloth fluff of the rubbing cloth when rotating in the second direction.

19. The method of claim 13, wherein a pressing depth of rubbing cloth fluff of the rubbing cloth when rotating in the first direction is different from a pressing depth of the rubbing cloth fluff of the rubbing cloth when rotating in the second direction.

20. The method of claim 8, wherein a pressing depth of rubbing cloth fluff of the rubbing cloth when rotating in the first direction is smaller than a pressing depth of the rubbing cloth fluff of the rubbing cloth when rotating in the second direction.

21. The method of claim 9, wherein a pressing depth of rubbing cloth fluff of the rubbing cloth when rotating in the first direction is smaller than a pressing depth of the rubbing cloth fluff of the rubbing cloth when rotating in the second direction.

22. The method of claim 10, wherein a pressing depth of rubbing cloth fluff of the rubbing cloth when rotating in the first direction is smaller than a pressing depth of the rubbing cloth fluff of the rubbing cloth when rotating in the second direction.

23. A display panel, manufactured by the method of claim 8.

24. A display panel, manufactured by the method of claim 9.

25. A display panel, manufactured by the method of claim 10.

26. A display panel, manufactured by the method of claim 11.

27. A display panel, manufactured by the method of claim 12.
